(19) United States
(12) Patent Application Publication
(10) Pub. No.: US 2015/0369663 A1
(43) Pub. Date: Dec. 24, 2015

(54) THERMO-OPTIC TUNABLE SPECTROMETER

(71) Applicant: EMPIRE TECHNOLOGY DEVELOPMENT LLC, Wilmington, DE (US)

(72) Inventors: Mordehai MARGALIT, Zichron Yaaqov (IL); Takahisa KUSUURA, Kanagawa (JP); Christopher A. WIKLOF, Everett, WA (US)

(73) Assignee: Empire Technology Development LLC.

(21) Appl. No.: 14/766,404

(22) PCT Filed: Feb. 6, 2013
(86) PCT No.: PCT/US2013/024896

§ 371 Date: Aug. 6, 2015

(51) Int. Cl. G01J 3/02; F25B 21/02; G01J 3/28

(52) U.S. Cl. CPC G01J 3/0286; G01J 3/021; G01J 3/2823; F25B 21/02

(57) ABSTRACT

A tunable spectrometer is described. A tunable spectrometer may include an optical filter, having a first reflector stack and a second reflector stack separated by a half-wave spacer, a heater, a heat-sink and a detector array. At least one of the first reflector stack, the second reflector stack, and the half-wave spacer is made from a thermo-optic material. The heater and the heat sink are separately in contact with at least one of the first reflector stack, the second reflector stack, and the half-wave spacer. The detector array is configured to collect an output from the optical filter. In various embodiments, the heat and the heat sink may be separated by an optically transparent thermal isolator.

### BACKGROUND

Measurement of properties of a light signal as a function of wavelength is referred to as spectroscopy. In general, splitting of a light signal into multiple bands having a range of wavelengths is achieved by a spectrometer. A typical spectrometer may use one of various methods to cause different wavelengths or ranges of wavelengths of light to follow different paths leading to one or more light sensors sensitive to a particular wavelength or range of wavelengths. Some spectrometers may use different narrow band filters, each configured to allow a narrow range of wavelengths to pass through to a sensor. As such, spectrometers tend to be physically large to allow for sufficient separation between the light sensors or filters to avoid interference from a neighboring light band. Accordingly, spectrometers having a small size and tunable filters are desired.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In some embodiments, a tunable spectrometer may include an optical filter, having a first reflector stack and a second reflector stack separated by a half-wave spacer, a heater, a heat-sink and a detector array. At least one of the first reflector stack, the second reflector stack, and the half-wave spacer is made from a thermo-optic material. The heater and the heat sink are separately in contact with at least one of the first reflector stack, the second reflector stack, and the half-wave spacer. The detector array is configured to collect an output from the optical filter. In various embodiments, the heater and the heat sink may be separated by an optically transparent thermal isolator.

In some embodiments, a method of making a tunable spectrometer may include providing a detector array having a light collecting surface, providing a first reflector stack having a reflective surface facing the light collecting surface, providing a second reflector stack separated from the first reflector stack by a half-wave spacer and having a reflective surface facing away from the reflective surface of the first reflector stack to form an optical filter, disposing a heater, and disposing a heat-sink such that the heater and the heat-sink are separately in contact with at least one of the first reflector stack, the second reflector stack, and the half-wave spacer. At least one of the first reflector stack, the second reflector stack, and the half-wave spacer is made from a thermo-optic material. The heater and the heat-sink are configured to maintain a temperature gradient across at least one of the first reflector stack, the second reflector stack, and the half-wave spacer.

In some embodiments, a method of tuning a tunable spectrometer may include providing a temperature gradient along a reflective surface of a first reflector stack of the tunable spectrometer that includes an optical filter, having a first reflector stack and a second reflector stack separated by a half-wave spacer, a heater, a heat-sink and a detector array, whereby the temperature gradient determines the frequency of light transmitted by the optical filter. At least one of the first reflector stack, the second reflector stack, and the half-wave spacer is made from a thermo-optic material.

### BRIEF DESCRIPTION OF DRAWINGS

In the present disclosure, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

FIG. 1 depicts an illustrative schematic of a tunable spectrometer according to an embodiment.

FIG. 2 depicts an illustrative schematic of a tunable spectrometer according to an alternate embodiment.

FIG. 3 depicts an illustrative flow diagram for a method of making a tunable spectrometer according to an embodiment.

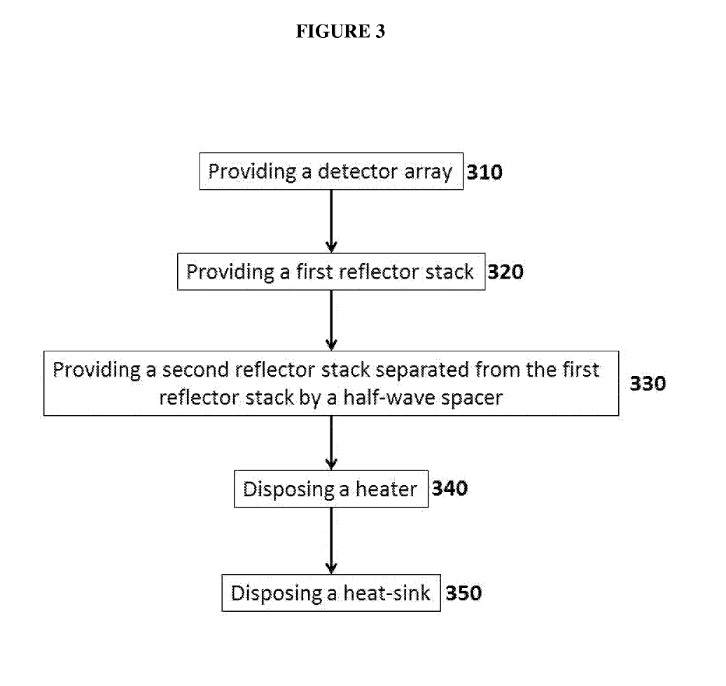

### DETAILED DESCRIPTION

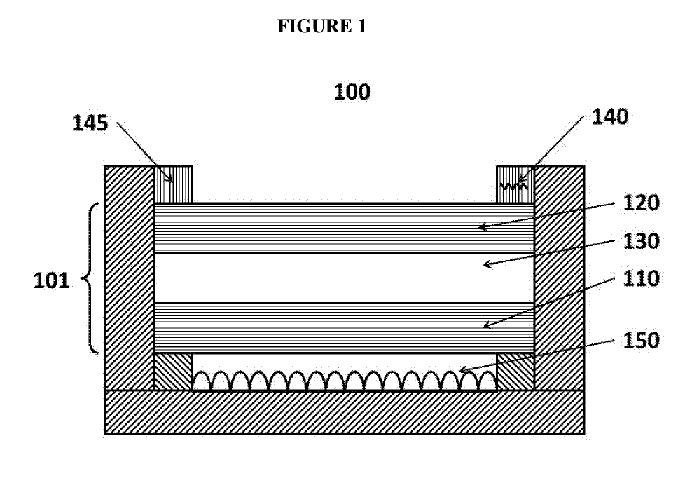

Described herein are a tunable spectrometer, methods of making the tunable spectrometer and methods of tuning the tunable spectrometer. As illustrated in FIG. 1, in some embodiments, a tunable spectrometer 100 may include an optical filter 101, having a first reflector stack 110 and a second reflector stack 120 separated by a half-wave spacer 130, a heater 140, a heat-sink 145, and a detector array 150. At least one of the first reflector stack 110, the second reflector stack 120, and the half-wave spacer 130 is made from a thermo-optic material. The heater 140 and the heat sink 145 are separately in contact with at least one of the first reflector stack 110, the second reflector stack 120, and the half-wave spacer 130. The detector array 150 is configured to collect an output from the optical filter 101. In various embodiments, the heater 140 and the heat sink 145 may be separated by an optically transparent thermal isolator (not shown).

As used herein, the term “thermo-optic material” refers to a material having a temperature-dependent refractive index. As used herein, the term “thermo-optic coefficient” refers to a rate of change of a refractive index with respect to temperature. Some thermo-optic materials may have a negative thermo-optic coefficient where the refractive index decreases with an increase in temperature. Other thermo-optic materials may have a positive thermo-optic coefficient where the refractive index increases with an increase in temperature. Examples of thermo-optic materials include, but are not limited to, glass, amorphous silicon, silicon nitride, silicon dioxide, germanium, silicon-germanium, gallium arsenide, magnesium fluoride, calcium fluoride, zirconium oxide, zinc oxide, tantalum oxide, doped zinc oxide, zinc sulfide, titanium dioxide, doped titanium oxide, tin oxide, doped tin oxide, diamond, and the like, acrylates, polyimides, chlorofluorinated polyimides, poly(phenylsilsesquioxane), poly(methyl methacrylate), epoxy resin, bisphenol A-resin, and the like, or any combination thereof.

The optical elements, such as the first reflector stack 110, the second reflector stack 120, and the half-wave spacer 130 of the optical filter 101 of the tunable spectrometer 100 may form a Fabry-Perot cavity such that for a particular refractive index of the optical elements and for a particular thickness of the half-wave spacer 130, radiation of only a particular wavelength, referred to herein as a “tuned wavelength”, is transmitted through the optical filter 101. As used herein, the term “tuned wavelength” refers to a single wavelength or a narrow band of wavelengths centered around the single wavelength that is transmitted by an optical filter. The narrow band may have a width of, for example, about 1 nanometer (nm), about 5 nm, about 10 nm, about 20 nm, about 50 nm, about 100 nm, about 150 nm, about 200 nm, or any value or range between any two of these values. The tuned wavelength for a particular configuration of the optical elements is dependent on the optical path length as determined by the refractive index and thickness of each of the optical elements. As used herein, the term “optical path length” refers to the product of the geometric length of the path that light follows through a material and the index of refraction of the material through which it propagates. For example, the optical path length, OPL, for a layer of thickness t having a refractive index n is OPL=n*t. For an optical filter including a first optical element having a refractive index n₁ and thickness t₁, a second optical element having a refractive index n₂ and thickness t₂, and a third optical element may be made from a thermo-optic material having a refractive index n₃ and thickness t₃, the optical path length is determined by:

OPL=n₁t₁+n₂t₂+n₃t₃ (Eq. I)

The tuned wavelength may be changed by varying the optical path length of an optical filter. Without wishing to be bound by theory, the optical path length of an optical filter may be changed by changing the temperature of any one of the optical elements, thereby changing the tuned wavelength. Alternatively, the tuned wavelength may be changed by changing the thickness of any one of the optical elements.

In some embodiments, one or more of the optical elements may be made from a thermo-optic material. For example, in some embodiments, only the first reflector stack 110 may be made from a thermo-optic material and in some embodiments, both the first reflector stack 110 and the second reflector stack 120 may be made from a thermo-active material. In certain embodiments, the half-wave spacer 130 may be made from a thermo-optic material. In some embodiments, the half-wave spacer 130 and the first reflector stack 110 may be made from a thermo-optic material. In alternate embodiments, the half-wave spacer 130 and the second reflector stack 120 may be made from a thermo-optic material. Likewise, any other combination of the optical elements may be made from a thermo-optic material. In particular embodiments, the first reflector stack 110 and the second reflector stack 120 may be made of, for example, a polyimide, and the half-wave spacer 130 may be made of, for example, amorphous silicon. In such embodiments, the optical path length may be varied by changing the temperature of any one or more of the three optical elements.

The optical elements may have any suitable thickness. For example, in some embodiments, any of the optical elements may have a thickness of about 50 nm to about 10 micrometer (μm). In some embodiments, the optical elements may have a thickness of about 50 nm, about 100 nm, about 250 nm, about 500 nm, about 1 μm, about 2.5 μm, about 5 μm, about 7.5 μm, about 10 μm or any value or range between any two of these values.

In particular embodiments, the half-wave spacer 130 may have a thickness such that the half-wave spacer provides an optical path length of about one-half a desired tuned wavelength. For example, if a desired tuned wavelength is about 660 nm (red), the half-wave spacer 130 may provide an optical path length of about 330 nm. Thus, if such a half-wave spacer 130 is made from a material having a refractive index of about 1.5, the half-wave spacer may have a thickness of t=330/1.5=220 nm. In some embodiments, the half-wave spacer 130 may have a thickness such that the optical path length is an odd integer multiple such as, for example, 3/2, 5/2, 7/2, 9/2, and the like, of half the tuned wavelength. In various embodiments, a desired tuned wavelength may be any wavelength from the infrared to the ultraviolet range of the electromagnetic spectrum.

In various embodiments, either or both the first reflector stack 110 and the second reflector stack 120 may have at least one reflective surface. In some embodiments, one or both of the first 110 and the second 120 reflector stacks include multiple layers each having a different thickness and a different refractive thickness. In certain embodiments, the multiple layers alternately have high and low refractive indices. In some embodiments, the multiple layers are deposited on an optically transparent substrate having a substantially flat dispersion curve over a desired range of wavelengths. In some embodiments, one or both of the first 110 and the second 120 reflector stacks may be configured to allow a desired range of wavelengths to transmit and reflect all other wavelengths by suitably choosing the thickness and refractive indices of the multiple layers. In certain embodiments, one or more of the multiple layers and/or the substrate may be made of a thermo-optic material. Without wishing to be bound by theory, in such embodiments the range of wavelengths that may be transmitted through the reflector stacks may be varied by changing the temperature of the one or more of the multiple layers and/or the substrate.

In various embodiments, the heater 140 may be any heating device known in the art. In certain embodiments, the heater 140 may be a resistive heating element such as, for example, a coil in contact with an optical element. In particular embodiments, the coil may be in the form of an electrically conductive path deposited on an optical element. For example, in some embodiments, the heater 140 may include a metallic or a semiconducting electrical element deposited or fabricated on a surface of an optical element. In some embodiments, the heater 140 may be a radiative or convective heater such as, for example, an infrared light source or a coil in proximity to an optical element.

In some embodiments, the heat-sink 145 may be any cooling device known in the art. In various embodiments, the heat-sink 145 may passively remove heat from an optical element. In certain embodiments, the heat-sink 145 may be a thermally conductive path in contact with an optical element connecting the optical element to a large heat reservoir. In some embodiments, the heat-sink 145 may include a structure having relatively large surface area that is made from a material having a relatively high thermal conductivity such as, for example, a metals, diamond, a semiconductor, and the like. In some embodiments, the heat-sink 145 may actively remove heat from an optical element. For example, in particular embodiments, the heat-sink 145 may include a Peltier cooler in contact with or in proximity of an optical element. In some embodiments, the heat-sink 145 may be fluid-cooled. In certain embodiments, the heat-sink 145 may be water-cooled or air-cooled. In various embodiments, more than one heat-sink 145 may be used for cooling the one or more optical elements.

In various embodiments, a plurality of heaters 140 and/or a plurality of heat-sinks 145 may be used for heating one or more optical elements. In some embodiments, the plurality of heaters 140 and/or heat-sinks 145 may be disposed on one or more of the optical elements. In certain embodiments, the plurality of heaters 140 may be resistive heaters that are made from optically transparent materials. In some embodiments, the plurality of heaters 140 and/or heat-sinks 145 may be configured to form spatial temperature gradients on one or more of the optical elements. For example, in some embodiments, the plurality of heaters 140 and/or heat-sinks 145 may be disposed on the one or more optical elements to create a concentric temperature gradient where a temperature of the one or more optical elements along a circle is constant and increases as the radius of the circle decreases; the highest temperature being at the center. In some embodiments, the spatial gradient may form multiple circles. In various embodiments, the spatial temperature gradient may be obtained using any suitable arrangement of the plurality of heaters 140 and/or heat-sinks 145. In some embodiments, the temperature gradient may have a square shape, a hexagonal shape, or any other regular or non-regular polygonal shape. In some embodiments, the temperature gradient may be increasing toward a center point or may be increasing outward away from the center point. In some embodiments, the temperature gradient may have any arbitrary shape.

The temperature of the one or more optical elements, in various embodiments, may vary from about −40° C. to about 500° C. In some embodiments, the temperature may vary from about −40° C. to about 50° C., from about −40° C. to about 100° C., from about −40° C. to about 150° C., from about −40° C. to about 200° C., from about −40° C. to about 250° C., from about −40° C. to about 300° C., from about −40° C. to about 400° C., from about −40° C. to about 500° C., from about −20° C. to about 50° C., from about −20° C. to about 100° C., from about −20° C. to about 150° C., from about −20° C. to about 200° C., from about −20° C. to about 250° C., from about −20° C. to about 300° C., from about −20° C. to about 400° C., from about −20° C. to about 500° C., from about 0° C. to about 50° C., from about 0° C. to about 100° C., from about 0° C. to about 150° C., from about 0° C. to about 200° C., from about 0° C. to about 250° C., from about 0° C. to about 300° C., from about 0° C. to about 400° C., from about 0° C. to about 500° C., from about 20° C. to about 50° C., from about 20° C. to about 100° C., from about 20° C. to about 150° C., from about 20° C. to about 200° C., from about 20° C. to about 250° C., from about 20° C. to about 300° C., from about 20° C. to about 400° C., from about 20° C. to about 500° C., from about 40° C. to about 50° C., from about 40° C. to about 100° C., from about 40° C. to about 150° C., from about 40° C. to about 200° C., from about 40° C. to about 250° C., from about 40° C. to about 300° C., from about 40° C. to about 400° C., from about 40° C. to about 500° C., or any value or range between any two of these ranges. The minimum and maximum temperatures used will depend on particular materials used to make the optical filters and on a particular frequency range desired.

In various embodiments, the plurality of heaters 140 and/or heat-sinks 145 may be connected by a thermally conductive path. In some embodiments, the plurality of heaters 140 and/or heat-sinks 145 may be connected by a thermally insulating path. The thermally conductive or thermally insulating paths of such embodiments may have any suitable shape or size depending on the temperature gradient desired.

Various embodiments may further include a programmable controller (not shown) for controlling the temperature gradient generated by the plurality of heaters 140 and/or heat-sinks 145. Any suitable controller may be used for controlling the temperature gradient. For example, if resistive heaters 140 and Peltier coolers 145 are used, the controller may include electric circuits designed to control current flowing through the resistive heaters 140 and Peltier coolers 145. In certain embodiments, the electric circuits may be configured to be controlled by a computer interface. In some embodiments, the controller is configured to allow real-time and on-demand changes in temperature or temperature gradient at a desired location on a surface of one or more of the optical elements. In some embodiments, the controller may include one or more temperature sensors disposed on one or more of the optical elements, or at another suitable location to determine a temperature or temperature gradient at a desired location on a surface of the one or more optical elements. Any temperature sensor known in the art may be used such as, for example, a thermistor, a thermocouple, a silicon bandgap sensor, and the like or any combination thereof.

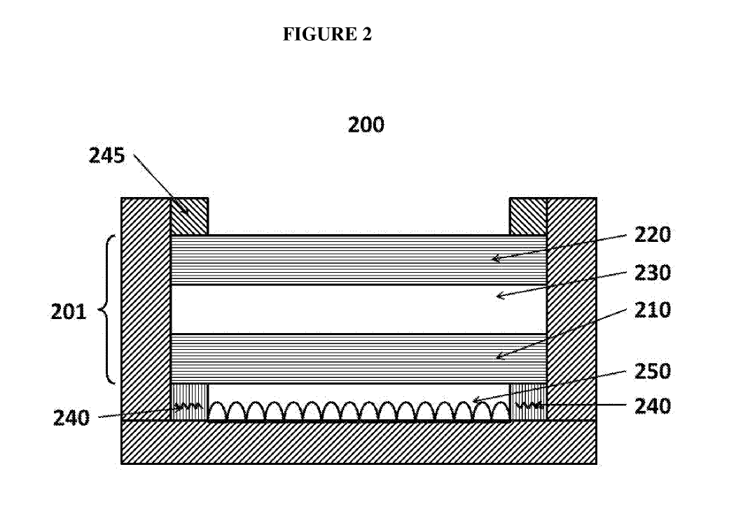

The detector array 150, in various embodiments, may include any optical detector configured to detect the desired frequency. For example, the detector array 150 may include photodiodes, linear CMOS image sensors, CCD arrays, photoresistors, reverse-biased LEDs, and the like, or any combination thereof. In some embodiments, a heater may be disposed on or near a light collecting surface of the detector array. For example, as illustrated in FIG. 2, a resistive heater 240 may be provided on the light collecting surface of a detector array 250 such that the heater 240 may radiatively heat one or more of the first reflector stack 210, the half-wave spacer 230, and the second reflector stack 220.

In some embodiments, the detector array 150 or 250 may include structures such as, for example, at least one microlens array to improve the sensitivity of the optical detectors. In some embodiments, the at least one microlens array may be provided on a surface of one or more of the detectors. For example, at least one microlens array may be deposited on a CCD array or a CMOS array. In some embodiments, the at least one microlens array may be provided on a surface of one or more of the optical elements such as, for example, on one of the reflector stacks. In certain embodiments, the at least one microlens array may be provided on a light-collecting surface of a reflector stack. Without wishing to be bound by theory, in such embodiments, the at least one microlens array may increase the amount of light collected by the reflector stacks, thereby increasing the amount of light transmitted to the detector array 150 or 250.

In various embodiments, the tunable spectrometer 100 may further include a calibration source (not shown) configured to provide light of a known frequency or frequencies. In such embodiments, the calibration source may be used as a reference for calibrating the tunable spectrometer. In some embodiments, the calibration source may be a monochromatic source such as, for example, a laser, or a narrow band-width source such as, for example, an LED, a sodium lamp, a mercury lamp, a xenon lamp, a halogen lamp, or the like. In some embodiments, the calibration source may be a white-light source such as, for example, an incandescent lamp, a fluorescent lamp, a white LED, and the like. In such embodiments, the calibration source may further include one or more optical filters configured to transmit light of one or more frequencies or bands of frequencies. Without wishing to be bound by theory, such known frequencies or bands of frequencies may be used to calibrate the spectrometer 100 by tuning the spectrometer for detecting the same frequencies or bands of frequencies. In such embodiments, the tunable spectrometer 100 may provide a maximum signal when the spectrometer is tuned for the frequencies or bands of frequencies emanating from the calibration source.

Embodiments are directed to methods of making a tunable spectrometer. In some embodiments, a method of making a tunable spectrometer may include providing 310 a detector array having a light collecting surface, providing 320 a first reflector stack having a reflective surface facing the light collecting surface, providing 330 a second reflector stack separated from the first reflector stack by a half-wave spacer and having a reflective surface facing away from the reflective surface of the first reflector stack to form an optical filter, disposing 340 a heater, and disposing 350 a heat-sink such that the heater and the heat-sink are separately in contact with at least one of the first reflector stack, the second reflector stack, and the half-wave spacer. At least one of the first reflector stack, the second reflector stack, and the half-wave spacer is made from a thermo-optic material. The heater and the heat-sink are configured to maintain a temperature gradient across at least one of the first reflector stack, the second reflector stack, and the half-wave spacer.

In some embodiments, one or more of the first reflector stack and the second reflector stack may be fabricated by alternately disposing layers of high and low refractive index materials on an optically transparent substrate. The layers of high and low refractive index materials may be disposed by any suitable means. For example, in some embodiments, the layers may be deposited on a suitable substrate using a process such as chemical vapor deposition, evaporation, pulsed laser deposition, electro-deposition, or any combination thereof. In some embodiments, the layers may be disposed using, for example, spin-coating, electrospinning, or the like, or any combination thereof.

In various embodiments, the high and low refractive index materials may be thermo-optic materials, and in certain embodiments, the optically transparent substrate may be made of a thermo-optic material. Examples of thermo-optic materials include, but are not limited to, glass, amorphous silicon, silicon nitride, silicon dioxide, germanium, silicon-germanium, gallium arsenide, magnesium fluoride, calcium fluoride, zirconium oxide, zinc oxide, tantalum oxide, doped zinc oxide, zinc sulfide, titanium dioxide, doped titanium oxide, tin oxide, doped tin oxide, diamond, acrylates, polyimides, chlorofluorinated polyimides, epoxy resin, bisphenol A-resin, poly(phenylsilsesquioxane), poly(methyl methacrylate), or any combination thereof. In some embodiments, the optically transparent substrate may be substantially optically transparent in the infrared to ultraviolet range of the electromagnetic spectrum. In certain embodiments, the transmittance of the optically transparent substrate may be about 99%, about 95%, about 90%, about 85%, about 80%, about 75%, about 70%, or any value or range between any two of these values. In some embodiments, the optically transparent substrate may have a transmittance that depends on the frequency (or wavelength) of light.

In some embodiments, a half-wave spacer may include a thin film of a suitable material disposed on the first reflector stack. The thin film may be disposed by any suitable means. For example, the thin film may be deposited using processes including, but not limited to, chemical vapor deposition, evaporation, pulsed laser deposition, electro-deposition, and the like. In an embodiment, the thin film may be disposed using spin-coating, electrospinning, or any combination thereof. In various embodiments, the thin film may be made of any thermo-optic material known in the art or described herein. In certain embodiments, the thin film may be made of amorphous silicon. The half-wave spacer may have any suitable thickness. In some embodiments, the thin film may have a thickness so as to provide an optical path length that is an odd integer multiple of half the tuned wavelength such as, for example, 3/2, 5/2, 7/2, 9/2, or the like. In various embodiments, a desired tuned wavelength may be any wavelength from the infrared to the ultraviolet range of the electromagnetic spectrum.

In certain embodiments, the second reflector stack may be disposed on the half-wave spacer. Any suitable process may be used to dispose the second reflector stack. As described herein, in various embodiments, the processes that may be used to dispose the second reflector stack may be the same or similar to the processes used to dispose the first reflector stack. In particular embodiments, a first reflector stack is deposited on one surface of an optically transparent substrate configured to be the half-wave spacer, and a second reflector stack is deposited on the second surface of the optically transparent substrate.

In some embodiments, one or more heaters and/or one or more heat-sinks may be disposed on one or more of the optical elements. In various embodiments, the heaters and/or heat-sinks may be suitably disposed on one of the surfaces of the one or more optical elements using a method such as, for example, chemical vapor deposition, physical deposition, evaporation, electro-deposition, electrospinning, spin-coating, or the like, or any combination thereof. In an embodiment, the method may further include, for example, a lithography step such as photolithography or electron-beam lithography. In certain embodiments, the heaters and/or the heat-sinks may be made of optically transparent materials.

In various embodiments that include at least one microlens array, the at least one microlens array may be deposited on the detector array and/or one or more of the optical elements using any suitable methods known in the art. Various methods for depositing the at least one microlens array include, but are not limited to, chemical vapor deposition, physical deposition, evaporation, electro-deposition, electrospinning, spin-coating, and the like, or any combination thereof. The methods may further include, for example, a lithography step such as photolithography or electron-beam lithography.

Embodiments are further directed to methods of tuning and using the tunable spectrometer described herein. In various embodiments, a method of tuning a tunable spectrometer may include providing a temperature gradient along a reflective surface of a reflector stack of the tunable spectrometer, whereby the temperature gradient determines a frequency of light transmitted by an optical filter of the tunable spectrometer.

In some embodiments, the temperature gradient may be provided by one or more heaters, one or more heat-sinks, or a combination thereof. The one or more heaters and/or the one or more heat-sinks may be in contact with one or more of the optical elements of the tunable spectrometer or, in some embodiments, the one or more heaters and/or the one or more heat-sinks may be in close proximity with one or more of the optical elements. In certain embodiments, the one or more heaters and/or the one or more heat-sinks may form an array configured to generate a temperature gradient of a desired shape. In such embodiments, the array of the one or more heaters and/or the one or more heat-sinks may be controlled by a controller as described herein.

For an optical element made from a thermo-optic material, changing the temperature of the optical element may change the refractive index of the optical element, and thereby the optical path length through the optical element. Without wishing to be bound by theory, if such an optical element is part of any optical filter described herein, the change in temperature may be sufficient to change the frequency transmitted by the optical filter. In some embodiments, providing a temperature gradient may include changing the temperature of one or more optical elements sufficient to change a frequency transmitted by the optical filter. The temperature gradient, in various embodiments, may have any shape. For example, in some embodiments, a temperature gradient may be circular where temperature is constant along a circumference of a circle. In such embodiments, the temperature may increase as the radius of the circle decreases with the highest temperature at the center. In some embodiments, the temperature gradient may have a square shape, a hexagonal shape, or any other regular or non-regular polygonal shape. In some embodiments, the temperature gradient may be increasing toward the center or may be increasing outward away from the center. In some embodiments, the temperature gradient may have any arbitrary shape.

In various embodiments, a temperature gradient across the surface of an optical element made from a thermo-optic material may provide a refractive index gradient having substantially the same shape as the temperature gradient. Without wishing to be bound by theory, such a refractive index gradient may result in transmission of different frequencies of light depending on the spatial location at which the light is incident on the spectrometer, thereby allowing a location dependent frequency distribution. For example, for a circular temperature gradient having the same temperature along the circumference of a circle, light at substantially the same frequency may be transmitted by the optical filter along the circumference.

### EXAMPLES

### Example 1

### A Tunable Spectrometer

A 220 nm thick layer of amorphous silicon is deposited on a substrate having alternate layers of polyimide and silicon nitride. The amorphous silicon layer is coated with alternate layers of tantalum oxide and silicon dioxide to form an optical filter. The substrate acts as the first reflector stack, the layers of tantalum oxide and silicon dioxide thin film act as the second reflector stack, and the amorphous silicon layer acts as the half-wave spacer. The optical filter is placed on a CCD array separated by a distance of about 200 μm such that the light transmitted by the optical filter is collected by the CCD array. A ring shaped resistive heater is placed in contact with the tantalum oxide/silicon dioxide layer of the optical filter to form the tunable spectrometer.

### Example 2

### Tuning a Tunable Spectrometer

In a tunable spectrometer of Example 1, a ring-shaped Peltier cooler is additionally placed in contact with the first reflector stack. A temperature gradient is created on either or both of the first reflector stack and the second reflector stack by appropriately heating or cooling the stacks. Addition of the Peltier cooler increases the range of temperatures that the spectrometer may be operated over, thereby increasing the frequency range over which the spectrometer may be tuned. By changing the temperature, the spectrometer may be tuned to a range of frequencies.

### Example 3

### Obtaining a Spatial Frequency Distribution

Multiple Peltier coolers and resistive heaters are placed in contact with the first reflector stack and the second reflector stack, respectively, of a tunable spectrometer as described in Example 1. The resistive heaters and the Peltier coolers are arranged and configured so as to obtain temperature gradient or gradients having any desired shape. Because temperature at a particular location governs the frequency transmitted by the optical filter at that location, a desired spatial distribution frequencies can be obtained by appropriately controlling the heat generated and removed by the resistive heaters and the Peltier coolers.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and a combination of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A tunable spectrometer comprising:
an optical filter comprising a first reflector stack and a second reflector stack separated by a half-wave spacer;
wherein at least one of the first reflector stack, the second reflector stack and the half-wave spacer comprise a thermo-optic material;
a heater in contact with at least one of the first reflector stack, the second reflector stack and the half-wave spacer;
a heat sink in contact with at least one of the first reflector stack, the second reflector stack and the half-wave spacer, wherein the heater and the heat sink are separated by an optically transparent thermal isolator; and
a detector array configured to collect an output from the optical filter.

2. (canceled)

3. The tunable spectrometer of claim 1, wherein the thermal isolator comprises at least one of air, mica, polyurethane, polystyrene, calcium silicate, and combinations thereof.

4. The tunable spectrometer of claim 1, wherein the thermo-optic material comprises one or more of glass, amorphous silicon, magnesium fluoride, calcium fluoride, zirconium oxide, zinc oxide, doped zinc oxide, zinc sulfide, titanium dioxide, doped titanium oxide, tin oxide, doped tin oxide, and diamond.

5. The tunable spectrometer of claim 1, wherein the thermo-optic material comprises one or more of chlorofluorinated polyimides, poly(phenylsilsesquioxane), poly(methyl methacrylate), epoxy resin, and bisphenol A-resin.

6. The tunable spectrometer of claim 1, wherein the half-wave spacer is amorphous silicon.

7. The tunable spectrometer of claim 1, wherein the heater comprises a resistive heater or a radiative heater.

8. The tunable spectrometer of claim 1, wherein the heat-sink comprises a Peltier cooler, an air-cooled metal piece, or a water-cooled metal piece.

9. The tunable spectrometer of claim 1, wherein one or more of the first reflector stack and the second reflector stack comprise alternate layers of high and low refractive index materials deposited on an optically transparent substrate.

10. The tunable spectrometer of claim 1, wherein the detector comprises a charge-coupled device (CCD) array, or a linear CMOS image sensor.

11. The tunable spectrometer of claim 1, further comprising a microlens provided on at least one of the detector array, the surface of the first reflector stack and the surface of the second reflector stack.

12. (canceled)

13. (canceled)

14. The tunable spectrometer of claim 1, further comprising a calibration source configured to provide light of a known frequency, wherein the calibration source is used as a reference for calibrating the tunable spectrometer.

15. A method of making a tunable spectrometer, the method comprising:
providing a detector array having a light collecting surface;
providing a first reflector stack having a reflective surface facing the light collecting surface;
providing a second reflector stack separated from the first reflector stack by a half-wave spacer and having a reflective surface facing away from the reflective surface of the first reflector stack to form an optical filter;
wherein at least one of the first reflector stack, the second reflector stack and the half-wave spacer comprise a thermo-optic material;
providing a heater in contact with at least one of the first reflector stack, the second reflector stack and the half-wave spacer;
providing a heat sink in contact with at least one of the first reflector stack, the second reflector stack and the half-wave spacer; and
separating the heater and the heat-sink by an optically transparent thermal isolator;
wherein the heater and the heat sink are configured to maintain a temperature gradient across at least one of the first reflector stack, the second reflector stack and the half-wave spacer.

16. (canceled)

17. The method of claim 15, wherein providing the heater comprises providing at least one of a resistive heater and a radiative heater.

18.-20. (canceled)

21. The method of claim 15, further comprising disposing a microlens on at least one of the detector, the first reflector stack and the second reflector stack, wherein the microlens is disposed using photolithography.

22. (canceled)

23. (canceled)

24. The method of claim 15, further comprising fabricating one or more of the first reflector stack and the second reflector stack by alternately disposing layers of high and low refractive index materials on an optically transparent substrate.

25. The method of claim 15, further comprising fabricating the optical filter by:
disposing a layer of high refractive index material on a first side of a substrate having a low refractive index to form a first reflector stack;
disposing a half-wave spacer on a second side of the substrate, disposing a layer of low refractive index material on the half-wave spacer; and
disposing a high refractive index material on the layer of low refractive index material to form a second reflector stack.

26. The method of claim 15, further comprising fabricating the optical filter by:
disposing a layer of low refractive index material on a first side of a substrate having a high refractive index to form a first reflector stack;
disposing a half-wave spacer on a second side of the substrate, disposing a layer of high refractive index material on the half-wave spacer; and
disposing a low refractive index material on the layer of high refractive index material to form a second reflector stack.

27. A method of tuning a tunable spectrometer, the method comprising:
providing a temperature gradient along a reflective surface of a first reflector stack of the tunable spectrometer;
wherein the tunable spectrometer comprises an optical filter comprising a first reflector stack and a second reflector stack separated by a half-wave spacer, wherein at least one of the first reflector stack, the second reflector stack and the half-wave spacer comprise a thermo-optic material;
providing a heater and a heat sink in contact with at least one of the first reflector stack, the second reflector stack and the half-wave spacer;
separating the heater and the heat-sink by an optically transparent thermal isolator; and
providing a detector array configured to collect an output from the optical filter;
whereby the temperature gradient determines a frequency of light transmitted by the optical filter.

28. The method of claim 27, wherein:
providing the heater comprises providing a resistive heater; and
providing a temperature gradient comprises applying an electric current to the resistive heater.

29. (canceled)

30. The method of claim 27, wherein:
providing the heat sink comprises providing a Peltier cooler; and
providing the temperature gradient comprises applying an electric current to the Peltier cooler.

31. (canceled)

32. The method of claim 27, wherein the tunable spectrometer further comprising:
providing a calibration source configured to provide light of a known frequency; and
providing, by the calibration source, a reference frequency for calibrating the spectrometer.

33. (canceled)

34. The method of claim 27, further comprising providing, by the heater and the heat sink, a two-dimensional temperature gradient on at least one of the first reflector stack, the second reflector stack and the half-wave spacer, whereby a two-dimensional distribution of frequencies is obtained.
